(19) United States
(12) Patent Application Publication
(10) Pub. No.: US 2012/0059768 A1
(43) Pub. Date: Mar. 8, 2012

(54) Method For Electronic Distribution Of Shipping Documents

(76) Inventor: John Ball, (US)

(21) Appl. No.: 12/876,186

(22) Filed: Sep. 6, 2010

(51) Int. Cl. G06Q 30/00

(52) U.S. Cl. 705/330

(57) ABSTRACT

A web sharing system for shippers, carriers, factoring companies, consignee, brokers and other entities involved in the transportation industry will be available. The system will store and allow for creation, confirmation and manipulation of documents in the website. All documents will be secure and available only to designed users. The system will be accessible from any web friendly device for viewing, creation, confirmation, or manipulation as allowed by the originator of the document. Notification of creation, confirmation, manipulation or failure to create, confirm or manipulate will be sent to parties involved in the process of billing, invoicing or verification of shipments, to a predetermined email address. All creations, confirmations and manipulations of documents will be digitally signed by the party initiating such action. All creation, confirmation and manipulation of documents will be recorded, dated and time stamped digitally on the website. All information will be available to designated parties 24 hours 7 days a week on the website.

### BACKGROUND OF THE INVENTION

The transaction process to enable the shipment of goods from a shipper to a consignee has been a cumbersome, manual process that has not substantially improved as an overall system in decades. The shipment transaction begins when a shipper contracts with a broker or motor carrier to transport product to a consignee. A rate confirmation is generated and faxed between the two parties to establish a price for the successful completion of transport. If one party is a broker, the broker and motor carrier also produce rate confirmations and fax between themselves. The motor carrier arrives at the shipper and is loaded with product. A bill of lading is produced and signed by the shipper and the driver. A copy of the bill of lading is given to the motor carrier to identify the load during transit. Upon delivery, the consignee signs the bill of lading and writes any remarks such as overage, shortage, or damage to the cargo. A copy of the bill of lading is given to the consignee and the driver retains another copy.

The driver mails or brings the bill of lading to the motor carrier. The motor carrier then creates an invoice for the load and mails the completed invoice to the individual that solicited the load or sends it to a factoring company. This individual could be the consignee, shipper, or a broker. The solicitor of the load then creates an invoice and mails it to the individual responsible for the payment of the load, if necessary.

One of the more burdensome aspects of the traditional process involves reaching agreement as to the final cost. If there is a dispute as to final cost, the shipper and carrier begin a burdensome and sometimes lengthy negotiation process in an attempt to settle the dispute. If the dispute is resolved, the shipper will then send payment to the carrier.

The traditional approach can lead to many disadvantages for a transaction between one shipper and one carrier. Typically, however, there are multiple carriers and shippers involved in multiple transactions, which makes the situation more complex, slow, and inefficient. The process is manually intensive in that it relies on the hard copy of the Bill of Lading (BOL) for proof of delivery and payment, resulting in a series of repetitive and time-consuming steps. Also, each BOL is often rated multiple times by multiple parties creating excessive redundancy.

Traditional transaction systems are also susceptible to errors. For example, there is no connection between the delivery of goods and when the shipper is billed for delivery. This may result in double billing, no billing at all, or over-billing the shipper for freight delivery charges. The carrier waits a disproportionately long time for payment while the invoice is being audited and/or disputed. For example, traditionally, a delivery takes about five days whereas payment takes about thirty days. This unnecessary delay adversely affects the carrier's working capital resources.

Many of the costs are individually small, but very large in aggregate. For example, the carrier incurs administrative costs including: the cost to create and deliver the initial invoice, costs of resolving billing disputes, costs of providing a signed copy of the BOL to the shipper, and the costs of posting accounts receivable. The shipper incurs similar administrative costs.

Since the process is largely conducted manually, it is very difficult to track a shipment. To learn of the status of a shipment or payment, there are various manual steps involved. For example, if the shipper wants to know if the carrier delivered the goods and if the payment has been made, the shipper must call the carrier and the appropriate financial institution.

There have been several attempts made to improve the existing shipment and payment process. Some improvements have been made to each separate step of completing a shipment transaction, but the entire method remains relatively unchanged. For example, shippers to schedule shipments and to process the invoice from the carrier use freight agents. In addition, third party service providers have taken over the role of managing the shipper's accounts payable department.

Another attempt to improve this burdensome transaction process involves the use of the Internet. Carriers have offered Internet access to their shipment information. Shippers access the carrier's Internet address and find out the immediate status of the shipment. However, the shipper is usually using multiple carriers. In this situation, the shipper separately accesses the address of each carrier in order to find out the status of each shipment that is unduly time consuming.

In the shipping/trucking industry, documents need to be exchanged among shippers, carriers, consignees, factoring companies, and brokers. Typical documents include BOL, confirmations, receipts, and invoices. The processing of these documents among the parties is complex and time consuming and there is no available method for facilitating this process electronically, particularly with the use of the Internet. The process for exchanging documents can take up to 10 days. What is needed is an electronic method of shipping documents exchange that requires only one to two days.

### DESCRIPTION OF THE INVENTION

The present invention is a business method for a clearinghouse to manage the electronic distribution of shipping documents, particularly for the trucking industry. The method is implemented on a communication network, preferably the Internet. The clearinghouse maintains a central server system connected to the Internet. The server system has a processor, memory, and data storage that are linked to the Internet or other communication networks by telephone, cable, or satellite, and the like. The clearinghouse server system implements required software programs and maintains a website that can be accessed by users through computers and related devices. All website pages are convertible to formats utilized by portable web-enabled devices.

In the present invention, the BOL is a legal document issued by the shipper to the transporter of goods at the time of loading. This document specifies the nature of the cargo, shipper, consignee, and any special handling instructions. The rate confirmation is a legal contract between the party offering a shipment and the motor carrier. This document specifies the conditions for successful completion of the transport of goods as well as the amount of payment expected by the motor carrier upon successful completion of transport. The invoice is a legal document between either the party providing transportation services or the party supplying the goods for sale. This document specifies the amount of payment expected by the transporter or seller. The shipper is the party providing the goods to be transported to the consignee. The consignee is the party receiving goods transported from the shipper. The motor carrier is the party providing logistical services to transport goods from the shipper to the consignee. The broker is an intermediary agent acting on behalf of the shipper or consignee to coordinate the logistics of transporting goods from shipper to consignee. A factoring company is a company that purchases the accounts receivables and bills on behalf of the client. The company typically pays the client a percentage of the invoice immediately with the remainder paid upon receipt of funds.

Users can access the clearinghouse website to electronically create forms, to fill in forms, and to digitally sign forms. The clearinghouse can review, store alter, and transmit forms. Forms include, but are not limited to, BOL, invoices, confirmation sheets, and receipts. Users include, but are not limited to, shippers, carriers, consignees, brokers, and their agents such as payors or payees.

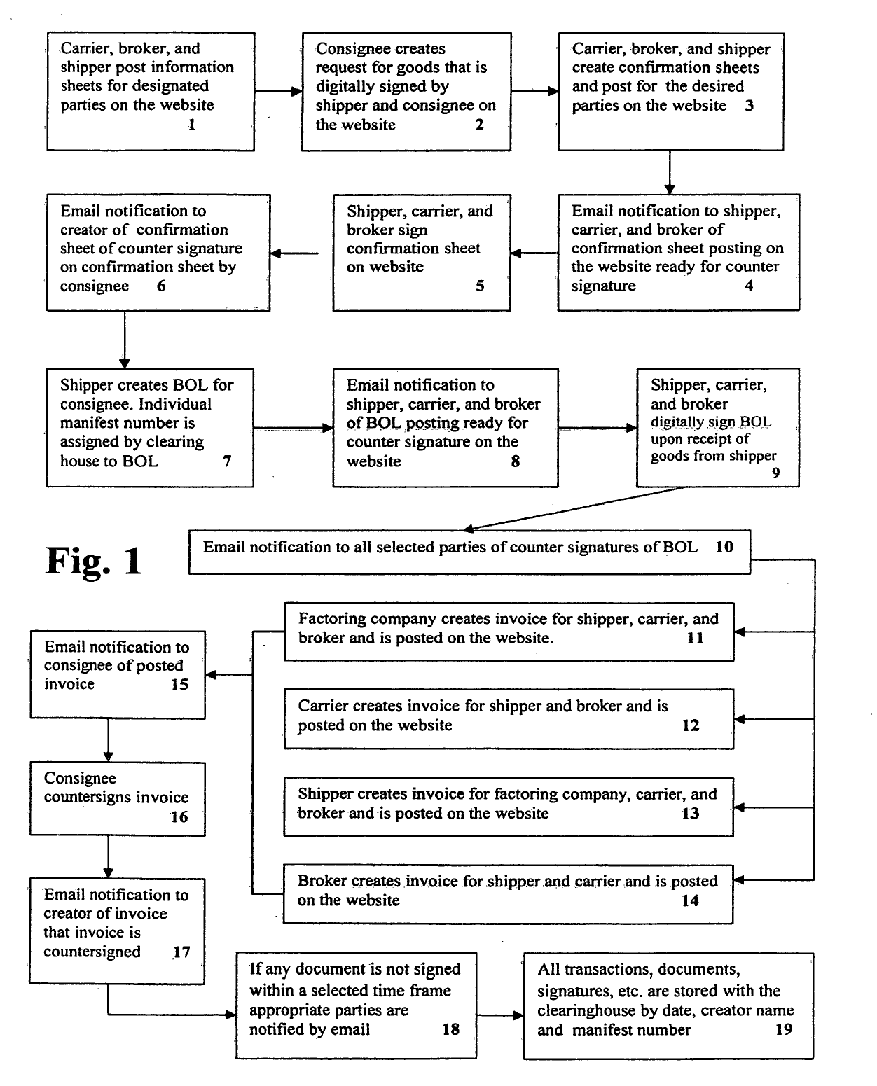

FIG. 1 shows the steps of the method of the present invention. The website hosted by the clearinghouse shall allow the carrier, broker, shipper, or any consignee to post information pages on the website (step 1). These information pages may contain information such as the name of a contact person, phone numbers, fax numbers, Federal tax ID numbers, mailing addresses, DOT numbers, names of insurance providers, the status of any of this information, or any information the user of the information page desires. The shipper or consignee can create a request for goods, such as a purchase order, that is digitally signed by the shipper and consignee on the website (step 2). The carrier, shipper, broker, or consignee may create a confirmation sheet as an agreement of terms between themselves and any participating party associated with the clearinghouse (step 3). After the confirmation sheet is created and posted on the website, the desired party may be notified of the confirmation sheet by email (step 4). Any of the desired parties may view the confirmation sheet posted on the clearinghouse website and digitally sign the confirmation sheet (step 5). An email is then sent to the creator of the confirmation sheet verifying that the desired parties (step 6) have digitally signed the confirmation sheet. The shipper may create a BOL and post the BOL on the website for the consignee or any desired parties to view; the clearinghouse server (step 7) assigns an individual manifest number to the BOL. Email notification is sent to the consignee of the posting of the BOL on the website (step 8). The consignee may view the BOL on the website and sign the BOL after receipt of goods from the carrier or transporter (step 9). The consignee may adjust the BOL on the website. An email is sent to all involved parties indicating that the consignee received the goods and documenting that the BOL is countersigned (step 10). The factoring company, the carrier, the shipper, or the broker may each create an invoice for their customer and post the invoice on the clearinghouse website (steps 11-14). An email is sent to the recipients of the invoices that the invoice is posted on the website for their viewing and signature (step 15). The recipients of the invoices countersign the invoice on the website (step 16). An email is sent to the creator of the invoice that the recipient of the invoice (step 17) has signed the invoice. If any document is not signed within a specified period, the appropriate parties are notified by email (step 18). All transactions, documents, signatures, and the like are stored on the clearinghouse server by date, name of the person that created the information, and manifest numbers (step 19). Approved parties may view these documents at any time.

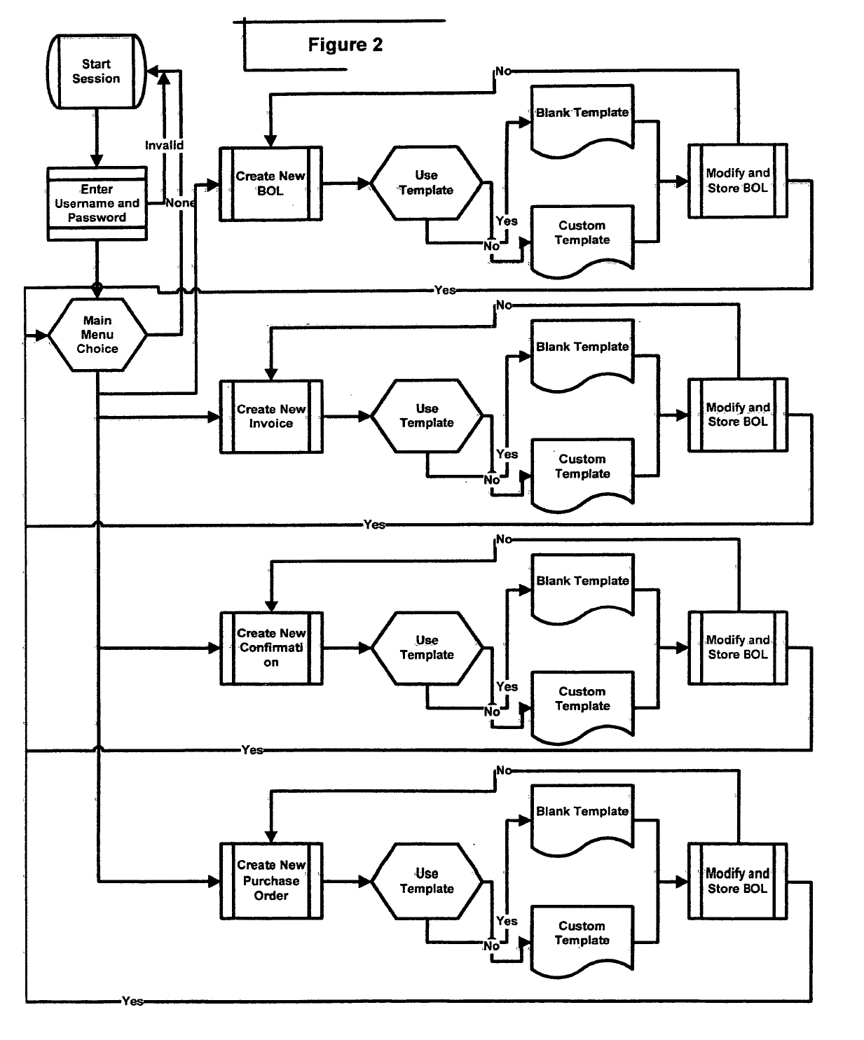

FIG. 2 shows a logic flow chart for the programming related to the creation of BOL, invoices, purchase orders, and confirmations on the clearinghouse website. A user logs into the website using a username and password. If the login is successful, a menu is provided to the user to select creating a new BOL, invoice, purchase order, or confirmation. The user can use a blank template provided by the website or can create a custom template on the website. The user can modify and store the template in the server system that returns the user to the main menu, or the user can create a new document.

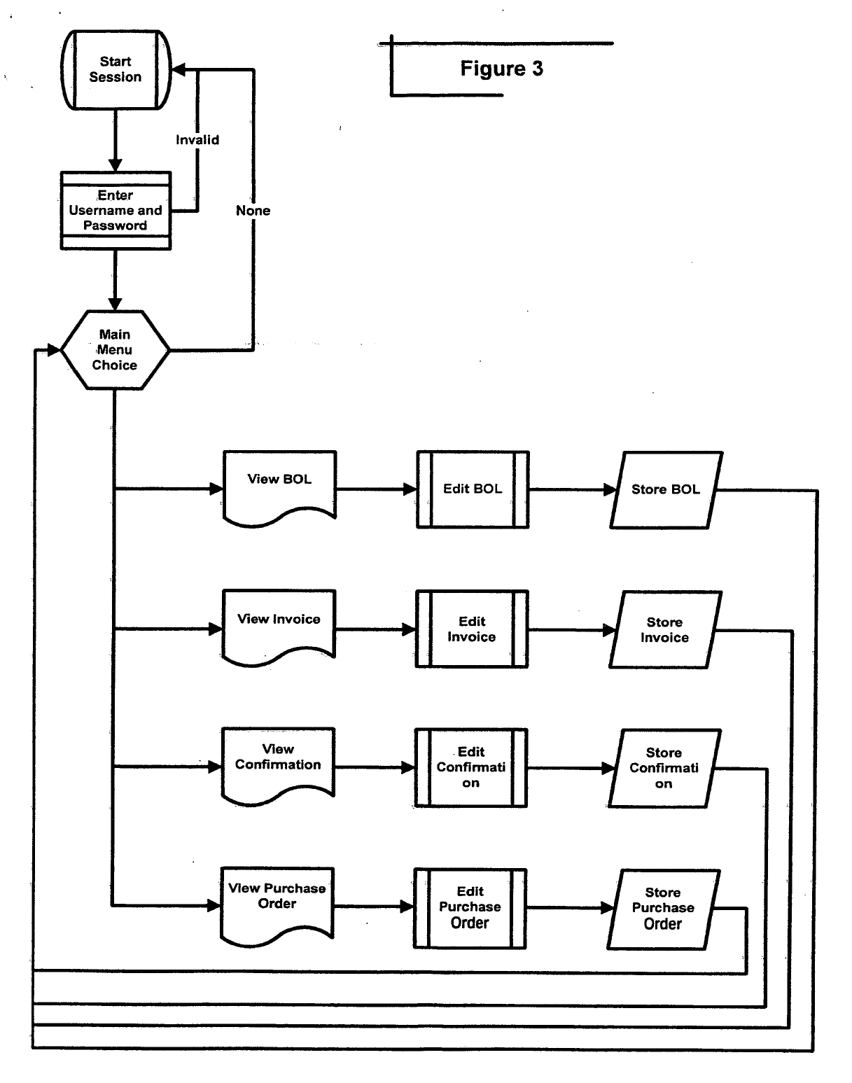

FIG. 3 shows a similar logic flow chart where a user can view a BOL, invoice, purchase order, or rate confirmation. The user has the option of editing the documents and storing them in the server system. If changes are made to the documents, emails of notification are sent to the creator of the changes and to the cosigners.

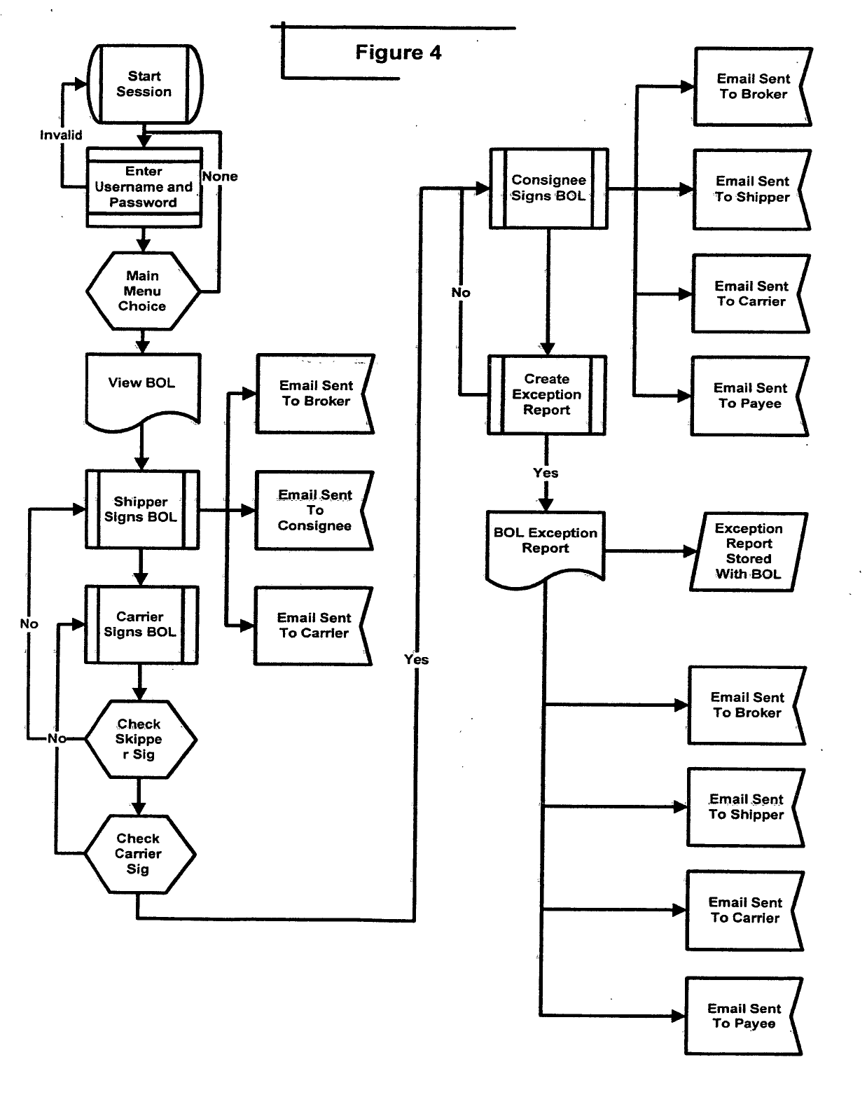

FIG. 4 shows a logic flow chart providing additional options under the view choice on the menu. A shipper can digitally sign the BOL on the website and the server system emails notification of the digitally signed BOL to the consignee and carrier that it is available on the website for viewing and adjustment. The carrier can also digitally sign the BOL after the server system has verified that the shipper has digitally signed the BOL. If the shipper has not signed, the shipper is requested by the server system to sign the BOL. If the shipper has signed the BOL, the server system checks to see if the carrier has digitally signed the BOL. If not, the server system will request the carrier to sign. If the carrier has signed, the server system will request the consignee to digitally sign the BOL. The consignee has the option of creating an exception report that is attached to the BOL. The BOL with the digital signatures of the shipper, carrier, and consignee are emailed by the server system to the shipper, carrier, and any necessary payee. The email may also include the BOL exception report, if any. The notification of signed documents may also be emailed to the broker.

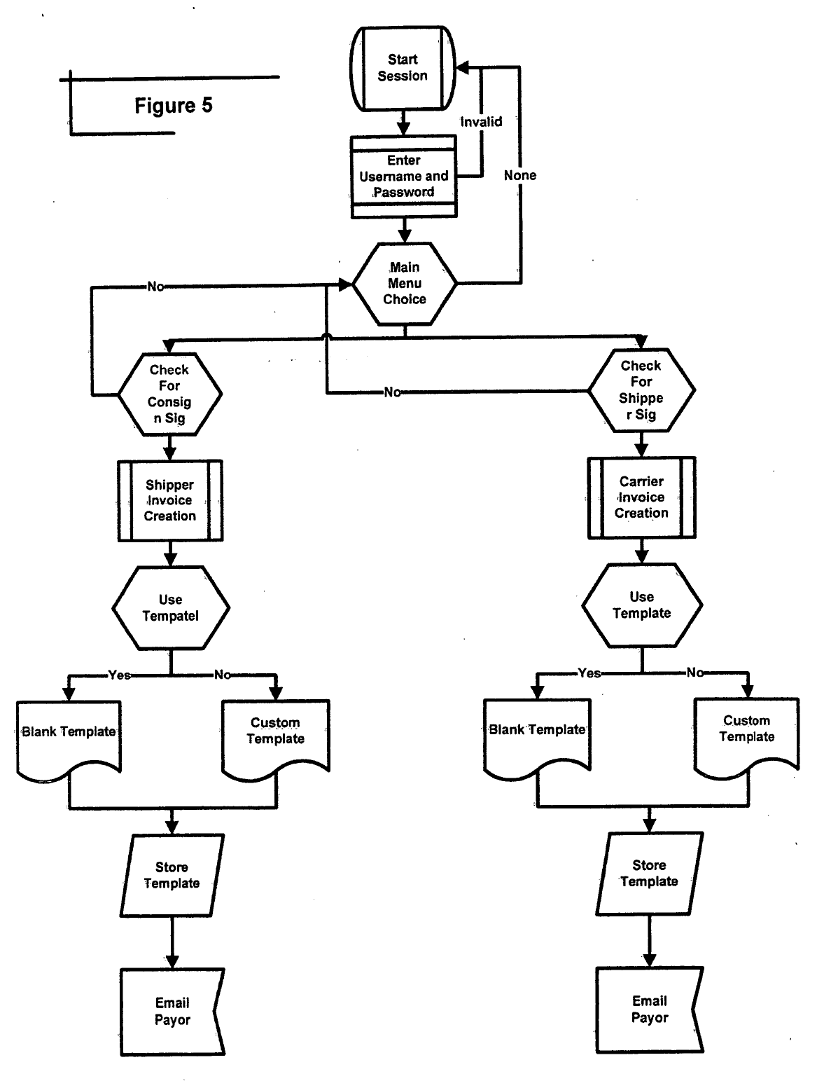

FIG. 5 shows a logic flow chart for creating an invoice on the website. The server system requires that the consignee has digitally signed the receipt for the delivered goods. I the receipt is signed, the user can choose a blank template or a custom template for the invoice. When the template is stored in the server system, the notification of the digitally signed invoice is emailed to the payor by the server system indicating that the document is available. Although FIG. 5 shows the logic flow paths for a shipper and carrier, a similar path is available for the broker.

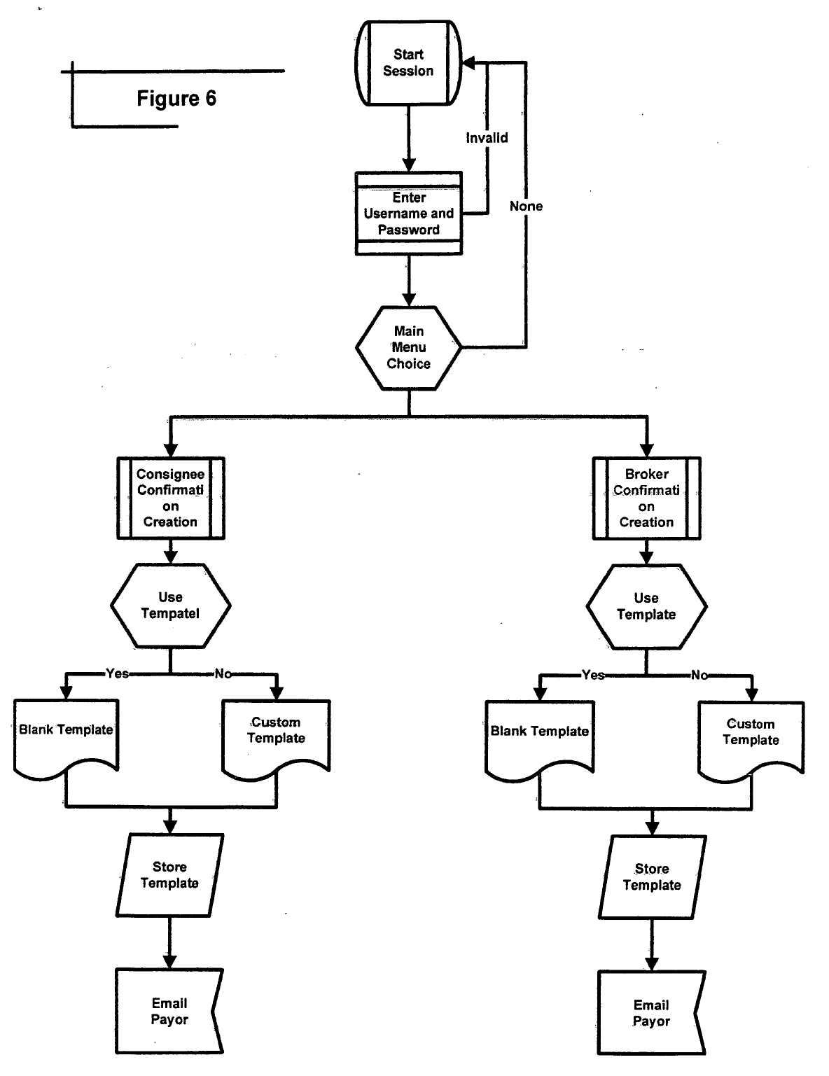

FIG. 6 shows a similar logic flow path for the creation of a confirmation by consignee and broker. The server system emails notification of the confirmation from the consignee to the shipper and from the broker to the carrier, indicating that it is available on the website.

Since all of these transactions are automatically implemented through a web-based Internet system by the clearinghouse server system, after input of information by users of the clearinghouse website, the proper transfer of shipping documents can be completed in 2 to 3 days, compared to the existing manual process which requires up to 10 days. The reduction in time for transferring shipping documents by the present invention produces substantial savings in time and money compared to the existing manual transfer systems.

What is claimed is:

1. A method for bringing together all parties involved in the movement of freight with an independent, secure electronic clearinghouse connected to each party by the Internet. The appropriate party creates all shipping documents on the clearinghouse. These documents can be custom prepared by the individual or created using standard templates provided by the clearinghouse. Changes are tracked and maintained for each document on the clearinghouse. All documents are stored and archived at the secure clearinghouse negating the costs associated with handling, filing, retrieval, and security.

2. A method for each party to digitally sign necessary shipping documents, creating legal and binding contracts. All of these documents are accessible to appropriate parties throughout the transportation process negating the need for faxing, mailing, or hand delivery thereby saving considerable time and expense. Notification of completion of each step in the document process will be provided using electronic mail. All documentation and emails will be stored with appropriate time and date stamps as well as an audit trail of individuals creating and accessing each document.

3. A method for standardizing the creation, viewing, editing, and digitally signing transportation documents through the use of any web enabled device including, but not limited to personal computers, workstations, personal data assistants (PDA), pocket computers, and web enabled cell phones with built in browsers.
